(19) United States
(12) Patent Application Publication
(10) Pub. No.: US 2010/0264789 A1
(43) Pub. Date: Oct. 21, 2010

(54) SPA APPARATUS

(76) Inventors: Quy That Ton, Baton Rouge, LA (US); Loan Nguyen, Baton Rouge, LA (US)

Correspondence Address: DUANE MORRIS LLP - Atlanta;IP DEPARTMENT, ATLANTIC CENTER PLAZA, 1180 WEST PEACHTREE STREET, NW SUITE 700, ATLANTA, GA, 30309-3348, US

(21) Appl. No.: 12/426,381

(22) Filed: Apr. 20, 2009

(51) Int. Cl. A47K 1/04; A47C 7/50; A47C 31/00; G06F 13/00; G05B 15/00; A47C 7/62; F21V 33/00

(52) U.S. Cl. 312/228; 297/423.1; 297/217.3; 710/304; 700/275; 297/217.4; 362/101

(57) ABSTRACT

Spa apparatuses are provided. In this regard, a representative spa apparatus, among others, includes a basin structure and housing. The housing has an outer surface that has a partial oval shape and an opening that is located in front of the housing and designed to contain a chair. The housing is coupled to the basin structure at a bottom portion of the housing.

### TECHNICAL FIELD

The present disclosure is generally related to spa apparatuses and, more particularly, is related to spa apparatuses having a housing that has a partial oval shape.

### BACKGROUND

The pedicure industry is expanding in today's economy. A pedicure spa is located in many pedicure salons. Customers sit at the pedicure spa where technicians can provide pedicure services as well as spa services. Typically, the pedicure spas are arranged next to each other and the pedicure salons have a central sound system, e.g., music box, to play music for all customers to hear. The customers either listen to the music over the central sounds system or use their personal portable handheld multimedia devices with ear phones.

### SUMMARY

Spa apparatuses are provided. In this regard, a representative spa apparatus, among others, includes a basin structure and housing. The housing has an outer surface that has a partial oval shape and an opening that is located in front of the housing and designed to contain a chair. The housing is coupled to the basin structure at a bottom portion of the housing.

Other apparatuses, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a rear view of an embodiment of a work station in accordance with the disclosure;

FIG. 2 is a front view of the work station, such as that shown in FIG. 1;

FIG. 3 is a block diagram that illustrates an embodiment of electrical components of the spa apparatus, such as that shown in FIG. 1;

FIG. 4 is a block diagram that illustrates yet another embodiment of electrical components of a spa apparatus, such as that shown in FIG. 1;

FIG. 5 is a block diagram that illustrates an embodiment of a network including spa apparatuses, such as that shown in FIG. 4; and

FIG. 6 is a block diagram illustrating an exemplary architecture for a computing device, local server and central server, such as that shown in FIG. 5.

### DETAILED DESCRIPTION

Exemplary spa apparatuses are first discussed with reference to the figures. Although these spa apparatuses are described in detail, they are provided for purposes of illustration only and various modifications are feasible.

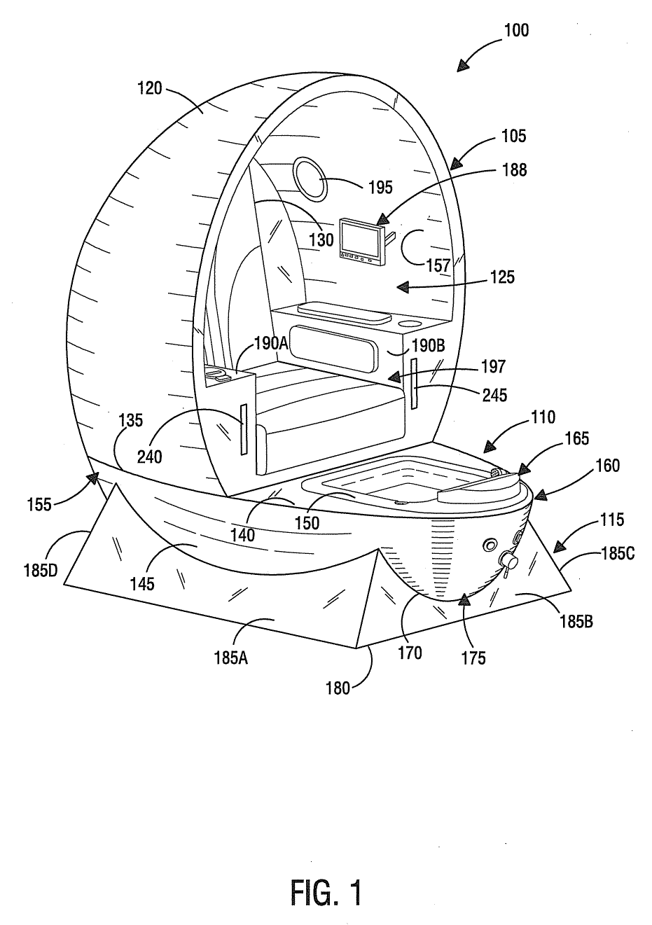

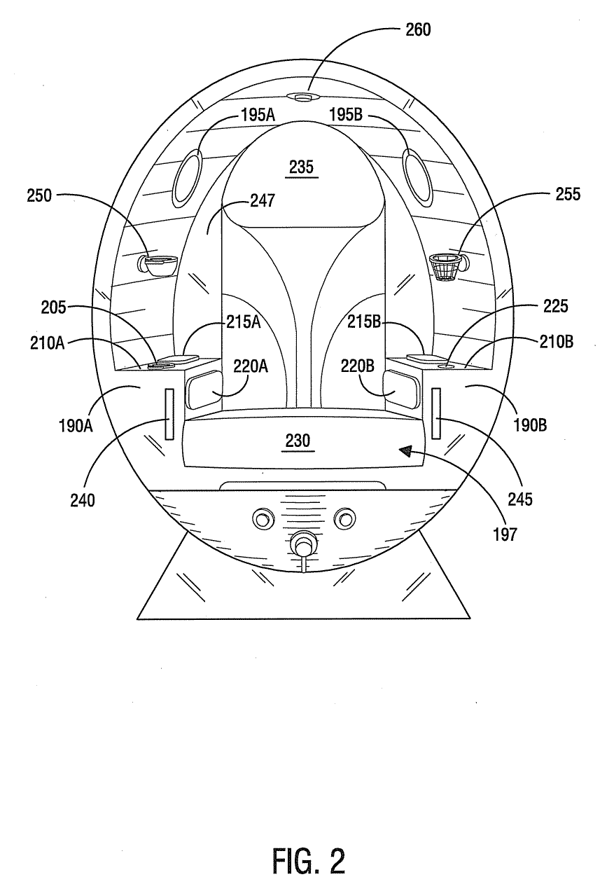

FIG. 1 is a perspective view that illustrates an embodiment of a spa apparatus 100 in accordance with the disclosure. The spa apparatus 100 includes, but is not limited to, a housing 105, a basin structure 110, and a base 115. The housing 105 has an opening 125 that is located in front of the housing 105 and designed to contain a chair or a message chair 130, with optional heating options. The housing 105 is coupled to the basin structure 110 at a bottom portion 135 of the housing 105. In this example, the housing 105 has an outer surface 120 that has a partial oval shape. The bottom portion 135 of the housing 105 is placed on top and conforms to the shape of a top surface 140 of the basin structure 110 such that the outer surface 120 of the housing 105 smoothly connects with the outer surface 145 of the basin structure 110. This is shown and further described in relation to FIG. 2.

The outer surface 145 of the basin structure 110 has a partial oval shape and rests on the base 115. The housing 105 is placed on the top surface 140 and at a rear end 155 of the basin structure 110. The basin structure 110 includes a basin 150 that is placed on the top surface 140 and at a front end 160 of the basin structure 110. In this example, the basin 150 is place in front of the opening 125 of the housing 105. A footrest 165 is positioned on top of the basin 150 and between the basin 150 and the front of the basin structure 110. The footrest 165 can be attached to either the basin structure 110 or the basin 150, or both. For example, the footrest 165 can be attached between the basin 150 and the front end 160 of the basin structure 110. Alternatively or additionally, the basin structure 110 and the base 115 are manufactured as one piece without mechanically attaching or chemically bonding the basin structure 110 and the base 115 together.

The basin structure 110 is mounted on top of the base 115. The top wall 170 of the base 115 is concaved and conforms to the shape of a bottom portion 175 of the basin structure 110. The base 115 further includes a bottom wall 180 that has a larger width and length than the top wall 170. The side walls 185A-D incline from the bottom wall 180 to the top wall 170. The top edges of the side walls 185A-D are concaved and conform to the shape of the bottom portion 175 of the basin structure 110.

The opening 125 of the housing 105 substantially conforms to the chair 130. In this example, arm rests 190A-B are integrally connected to the inner surface 157 of the housing 105. Between the arm rests 190A-B forms a chair slot 197 that the chair 130 can be placed therein. The top left and right of the inner surface 157 includes speaker devices 195 that can produce sounds for playing, e.g., music. Alternative or additionally, the arm rests 190A-B can attached to the chair 130 and a display device 188 can be attached to the right side wall of the inner surface 157. The display device 188 is electrically coupled to a multimedia docking station 205, 250 (FIG. 2). The interior of the housing 105 is further described in relation to the FIG. 2.

FIG. 2 is a front view that illustrates an embodiment of the spa apparatus 100, such as that shown in FIG. 2. The interior of the housing 105 further includes the arm rests 190A-B that are positioned at left and right sides of the interior of the housing 105. In this example, the top walls 210A-B of the arm rests 190A-B include arm cushions 215A-B, a multimedia docking station 205 for a media player, such as, an IPod player, MP3 player, DVD Player, and laptop, and a hole 225 as a cup holder, respectively. The side walls of the arm rests 190A-B include side cushions 220A-B. The bottom cushion 230 and a back cushion 235 of the chair 130 rest in the chair slot 197 and the rear wall 247 of the inner surface 157, respectively.

The housing 105 includes speaker devices 195A-B that are positioned on the interior of the housing 105 and electrically coupled to the multimedia docking station 205 of the media player. In this example, the speaker devices 195A-B are attached to the top left and top right of the inner surface 157, respectively. In general, the speaker devices 195A-B are located in the housing 105 such that sounds from the speaker devices 195A-B are substantially contained within the housing 105.

Additionally or alternatively, the speaker devices 195A-B can be mounted on the chair 130 or on the basin structure 110, and one or more light bulbs 260 can be mount on the inner surface 157. Additionally or alternatively, a display device 240 and a keyboard/mouse 245 can be attached to the arm rests 190A-B via an extension structure (not shown). The display device 240 and keyboard/mouse 245 can slide into respective compartments in the arm rests 190A-B or adjusted such that the display device 240 and keyboard/mouse 245 are placed flat against the front surface of the respective arm rests 190A-B.

Additionally or alternatively, a multimedia docking station 250 can be attached to the left side wall of the inner surface 157 of the housing 105. The multimedia docking station 250 can swivel such that a user can adjust a multimedia player docked in the multimedia docking station 250 to better view the display on the multimedia player. Additionally or alternatively, headphone ports (not shown) can be mounted on the multimedia docking station 250 and/or the side wall of the housing 105. A headphone can be used via the headphone ports to listen to music or videos from the multimedia player. Additionally or alternatively, a cup holder 255 can be attached on the right side wall of the inner surface 157 of the housing 105. The cup holder 255 can swivel such that a user can easily insert or take a cup out of the cup holder 255. Although FIGS. 1 and 2 show a housing that has the outer surface 120 having a partial oval shape, the outer surface 120 can have any geometric shapes, such as polyhedron shapes (e.g., pyramid, cube, etc.) and conical. Additionally or alternatively, windows (not shown) can be installed on the side wall of the housing so that users can see each other, especially if they know each other. Additionally or alternatively, the spa apparatus 100 can include intercoms so that users can speak and listen to each other.

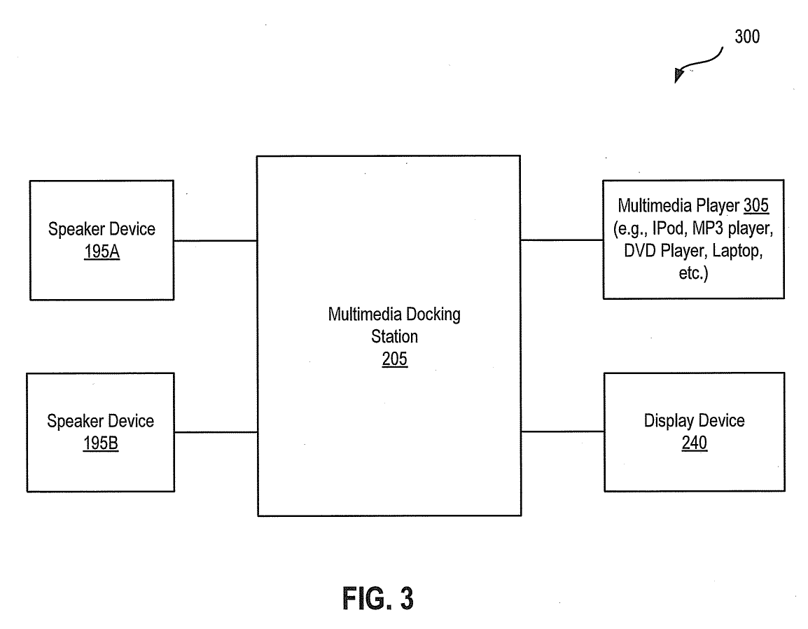

FIG. 3 is a block diagram that illustrates an embodiment of electrical components of the spa apparatus 300, such as that shown in FIG. 1. The spa apparatus 300 includes a multimedia docking station 205 that is coupled to speaker devices 195A-B, and a display device 240. The multimedia docking station 205 can receive and be electrically coupled to a multi-media player 305, such as an IPod, MP3 player, DVD player, and any other similar multimedia devices. A user on the spa apparatus 100 can either listen to music and/or watch a video using the display device 240 and/or speaker devices 195A-B using the multi-media player 305 on the multimedia docking station 205.

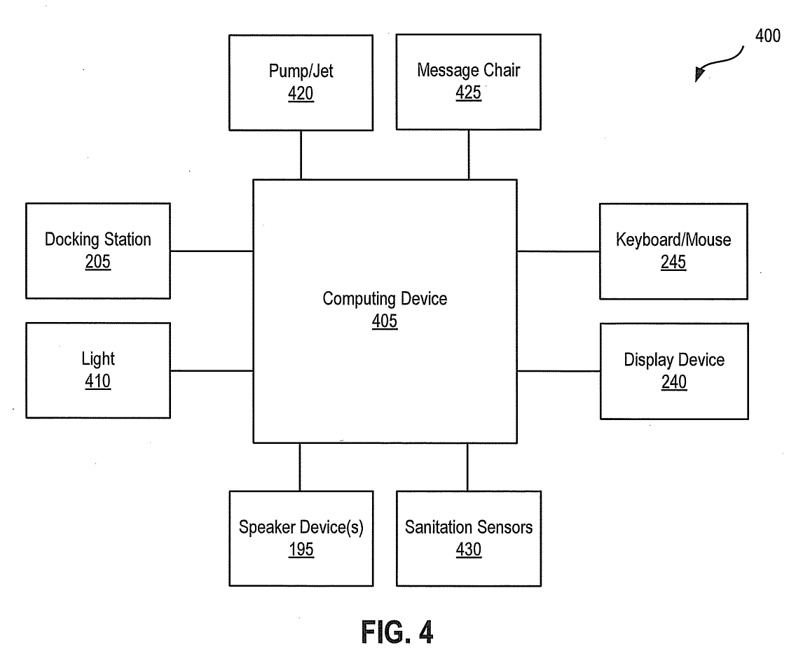

FIG. 4 is a block diagram that illustrates yet another embodiment of electrical components of a spa apparatus 400, such as that shown in FIG. 1. The spa apparatus 400 can include a computing device 405 that is coupled to the speaker devices 195A-B, lights 410 and the display device 240. Although it is shown that the multimedia docking station 205 and the speaker devices 195A-B are connected to the computing device 405, it should be noted that the multimedia docking station 205 can be directly coupled to the speaker devices 195 and display device 240. The computing device 405 can communicate with the multi-media player 305 via the multimedia docking station 205. The information received from the multi-media player 305 is then relayed or transmitted to the speaker devices 195A-B and/or display device 240 via the computing device 405.

Other components are electrically coupled to the computing device 405 such as sanitation sensors 430, a pump/jet 420 and a massage chair 425. The computing device 405 can display functionalities and operational features of the pump/jet 420, massage chair 425, and sanitation characteristics of the spa apparatus 400 to facilitate the user controlling the pump/jet 420, massage chair 425, and lights 410 via a user interface device such as a keyboard/mouse 245 and/or via the display device 240 (e.g., a touch screen device). Additionally or alternatively, the spa apparatus 400 enables the user to listen to music and/or watch video via the speaker devices 195A-B and/or the display device 240, retrieving music and video information from the computing device 405.

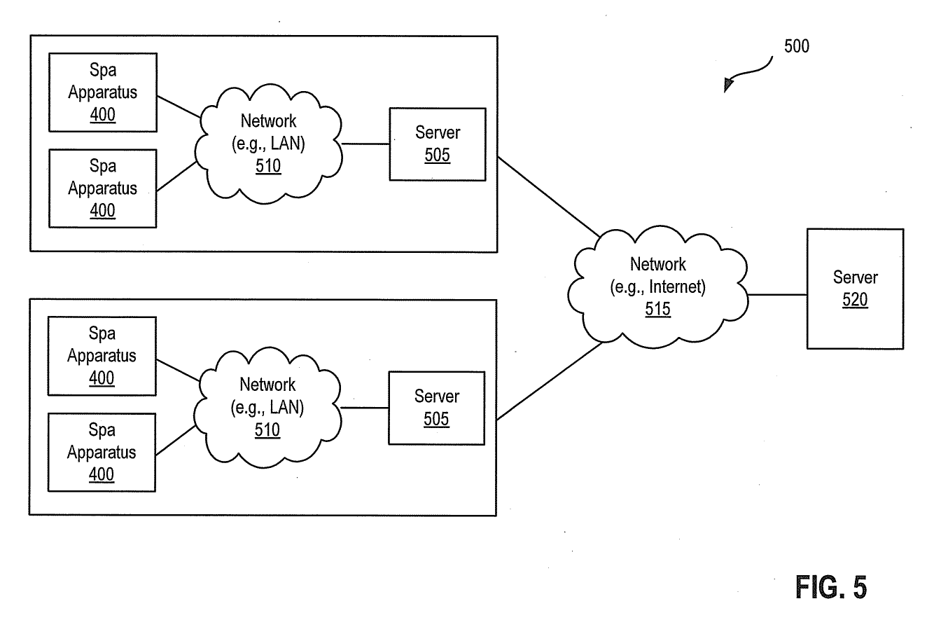

FIG. 5 is a block diagram that illustrates an embodiment of a system 500 including spa apparatuses, such as that shown in FIG. 4. The system 500 includes at least one location 501A-B, which includes spa apparatus 400A1-A2, 400B1-B2 connected to networks 510A-B, respectively. Local servers 505A-B can communicate to the spa apparatus 400A1-A2, 400B1-B2 via the networks 510A-B (e.g. local area networks (LANs)), respectively. Each location 501A-B can communicate with a central server 520 via network 515 (e.g., Internet).

The local server 505A-B can control the spa apparatus 400A1-A2, 400B1-B2, such as, playing certain music and/or video or operate certain functionality associated with the lights 410, pump/jet 420, and massage chair 425. In yet another example, the local server 505A-B can be used as a multi-media database such that the spa apparatus 400A1-A2, 400B1-B2 can retrieve music and video stored in the local server 505A-B that the user can select and play back. The local server 505A-B can update the multi-media database to add or delete music and video from the central server 520 via the internet 515. Not only can music and video can be updated but advertisement can be also updated from the central server 520, which uploads the advertisement to the local servers 505A-B and plays back the uploaded advertisement to the customers using the speaker devices 195A-B and/or display device 240 attached to the spa apparatus 400A1-A2, 400B1-B2.

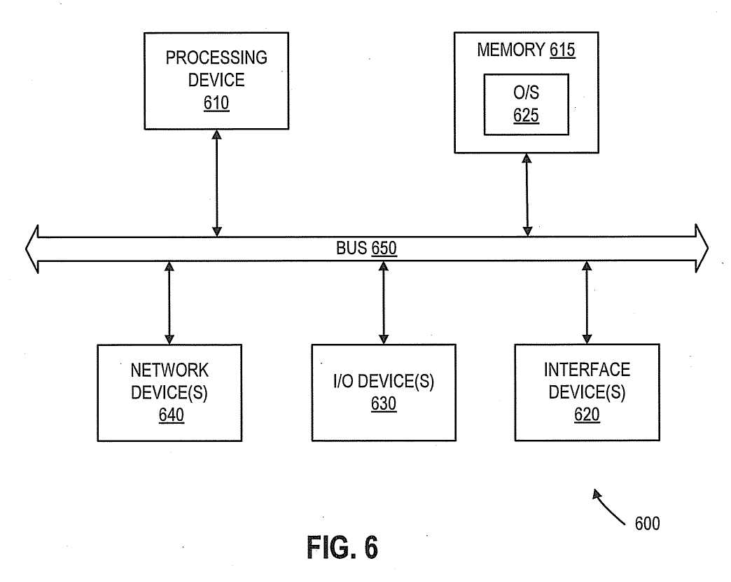

FIG. 6 is a block diagram illustrating an exemplary architecture for a generic computer 600 that is similar to the architecture of the computing device, local server and central server, such as that shown in FIG. 5. As indicated in FIG. 6, the generic computer 600 comprises a processing device 610, memory 615, one or more user interface devices 620, one or more I/O devices 630, and one or more networking devices 640, each of which is connected to a local interface 650. The processing device 610 can include any custom made or commercially available processor, a central processing unit (CPU) or an auxiliary processor among several processors associated with the generic computer 600, a semiconductor based microprocessor (in the form of a microchip), or a macroprocessor. The memory 615 can include any one or a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 620 comprise those components with which the user (e.g., administrator) can interact with the generic computer 600. Where the generic computer 600 comprises a server computer or similar device, these components can comprise those typically used in conjunction with a PC such as a keyboard and mouse.

The one or more I/O devices 630 comprise components used to facilitate connection of the generic computer 600 to other devices and therefore, for instance, comprise one or more serial, parallel, small system interface (SCSI), universal serial bus (USB), or IEEE 1394 (e.g., Firewire™) connection elements. The networking devices 640 comprise the various components used to transmit and/or receive data over networks 510, 515, where provided. By way of example, the networking devices 640 include a device that can communicate both inputs and outputs, for instance, a modulator/demodulator (e.g., modem), a radio frequency (RF) or infrared (IR) transceiver, a telephonic interface, a bridge, a router, as well as a network card, etc.

The memory 615 normally comprises various programs (in software and/or firmware) including an operating system (O/S) 625. The O/S 625 controls the execution of programs, and provides scheduling, input-output control, file and data management, memory management, and communication control and related services.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. A spa apparatus comprising:
a basin structure; and
a housing having an outer surface that has a partial oval shape and an opening that is located in front of the housing and designed to contain a chair, the housing being coupled to the basin structure at a bottom portion of the housing.

2. The spa apparatus as defined in claim 1, wherein the basin structure including a basin, the basin structure having an outer surface that has a partial oval shape, the housing being placed on a top surface and at a rear end of the basin structure, the basin being placed on the top surface and a front end of the basin structure.

3. The spa apparatus as defined in claim 2, further comprising a footrest that is positioned on top of the basin and between the basin and the front of the basin structure.

4. The spa apparatus as defined in claim 1, further comprising a base, the basin structure being mounted on top of the base.

5. The spa apparatus as defined in claim 4, wherein the base includes a top wall that substantially conforms to a bottom portion of the basin structure, the base further including a bottom wall that has a larger width than the top wall.

6. The spa apparatus as defined in claim 4, wherein the base includes a top wall that substantially conforms to a bottom portion of the housing, the base further including a bottom wall that has a larger width than the top wall.

7. The spa apparatus as defined in claim 1, wherein an interior of the housing substantially conforms to the chair.

8. The spa apparatus as defined in claim 7, wherein the interior of the housing includes a multimedia docking station that is positioned on a side wall of the housing.

9. The spa apparatus as defined in claim 8, wherein the housing includes speaker devices that are positioned on the interior of the housing and electrically coupled to a media player using the multimedia docking station, the speaker devices being located in the housing such that sounds from the speaker devices are substantially contained within the housing.

10. The spa apparatus as defined in claim 7, further comprising at least one light bulbs, display device and cup holder mounted on a side wall of the housing.

11. A spa apparatus comprising:
a basin structure having an outer surface that has a partial oval shape; and
a housing having an opening that is located in front of the housing and designed to contain a chair, the housing being coupled to the basin structure at a bottom portion of the housing, an interior of the housing being designed to substantially conform to the chair

12. The spa apparatus as defined in claim 11, further comprising a footrest that is positioned on top of the basin structure and between the basin and the front of the basin structure.

13. The spa apparatus as defined in claim 11, wherein the housing has any geometric shapes that include at least one of the following: a partial oval shape, conical shape, and any polyhedron shapes.

14. The spa apparatus as defined in claim 13, wherein the base includes a top wall that substantially conforms to a lower portion of the basin structure, the base further including a bottom wall that has a larger width than the top wall.

15. The spa apparatus as defined in claim 13, wherein the base includes a top wall that substantially conforms to a lower portion of the housing, the base further including a bottom wall that has a larger width than the top wall.

16. The spa apparatus as defined in claim 11, further comprising a multimedia docking station that is mounted on a side wall of the housing.

17. The spa apparatus as defined in claim 16, wherein the housing includes speaker devices that are positioned on the interior of the housing and electrically coupled to a media player using the multimedia docking station, the speaker devices being located in the housing such that sounds from the speaker devices are substantially contained within the housing.

18. The spa apparatus as defined in claim 17, further comprising at least one light bulbs, display device and cup holder mounted on a side wall of the housing.

19. A spa apparatus comprising:
a basin structure having a basin;
a chair that is attached to the top of the basin structure;
a multimedia docking station that is coupled to the chair; and
at least one speaker device that is electrically coupled to the multimedia docking station.

20. The spa apparatus as defined in claim 19, wherein the chair further includes arm rests, at least one arm rests having the multimedia docking station that is positioned on top of the at least one arm rests.

21. The spa apparatus as defined in claim 19, further comprising a display device is attached to the at least one arm rests.

22. The spa apparatus as defined in claim 21, further comprising a computing device that is coupled to the multimedia docking station, speakers, and display device.

23. The spa apparatus as defined in claim 19, wherein the computing device is configured to be coupled to at least one of the following devices: sanitation sensors, water pumps, and message chair, the computing device being configured to control the operational functionalities of at least one of the following devices: sanitation sensors, water pumps, and message chair.
